(19) United States
(12) Patent Application Publication
(10) Pub. No.: US 2025/0321009 A1
(43) Pub. Date: Oct. 16, 2025

(54) PIZZA STONE

(71) Applicant: WHIRLPOOL CORPORATION, BENTON HARBOR, MI (US)

(72) Inventors: Matteo Mancino, Milano (IT); Giulia Angelica Porcelli, Varese (IT); Michele Rosa, Induno Olona, Varese (IT)

(73) Assignee: WHIRLPOOL CORPORATION, BENTON HARBOR, MI (US)

(21) Appl. No.: 18/634,855

(22) Filed: Apr. 12, 2024

(51) Int. Cl. F24C 15/16; B32B 3/30; B32B 15/01

(52) U.S. Cl. CPC F24C 15/16; B32B 3/30; B32B 15/012

(57) ABSTRACT

A cooking apparatus includes a tray defining a receiving aperture. A cooking stone is selectively disposed within the receiving aperture of the tray, where the cooking stone separates from the tray when disposed over a heat source. The cooking stone includes a high-thermal mass layer defining a cooking surface, and an adapter layer coupled to a lower surface of the high-thermal mass layer. A lid is selectively disposed over the cooking surface.

### BACKGROUND OF THE DISCLOSURE

The present disclosure generally relates to a pizza stone and more specifically, to a pizza stone for use with a cooking appliance.

### SUMMARY OF THE DISCLOSURE

According to one aspect of the present disclosure, a cooking apparatus includes a tray defining a receiving aperture. A cooking stone is selectively disposed within the receiving aperture of the tray, where the cooking stone separates from the tray when disposed over a heat source. The cooking stone includes a high-thermal mass layer defining a cooking surface, and an adapter layer coupled to a lower surface of the high-thermal mass layer. A lid is selectively disposed over the cooking surface.

According to another aspect of the present disclosure, a pizza stone includes a tray defining a receiving aperture and a cooking stone selectively disposed within the receiving aperture. The cooking stone includes a high-thermal mass layer defining a cooking surface and an adapter layer coupled to a lower surface of the high-thermal mass layer.

According to yet another aspect of the present disclosure, a method for heating a cooking apparatus includes providing the cooking apparatus, where the cooking apparatus includes a tray defining a receiving aperture and a cooking stone selectively engages the receiving aperture, disposing the cooking stone over a heat source, where the cooking stone extends through the receiving aperture of the tray and is disengaged from the tray, and heating the cooking stone to a first temperature by activating the heat source. The method further includes heating a cooking cavity of a cooking appliance to an operation temperature, disposing the cooking apparatus within the cooking cavity, and disposing the food item on a cooking surface defined by the cooking stone.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an exploded side perspective view of a cooking apparatus including a tray, a cooking stone, and a lid, according to the present disclosure;

FIG. 2 is a front perspective view of a cooking appliance including a cooking cavity with a cooking apparatus disposed within the cooking cavity, according to the present disclosure;

FIG. 3 is a top plan view of a cooking appliance including a cooktop with a cooking apparatus disposed on a cooktop, according to the present disclosure;

FIG. 4 is a side perspective view of a tray for a cooking apparatus, according to the present disclosure;

FIG. 5 is a bottom plan view of a tray for a cooking apparatus, according to the present disclosure;

FIG. 6 is a top perspective view of a cooking apparatus including a tray and a cooking stone disposed in a receiving aperture of the tray, according to the present disclosure;

FIG. 7A is a side cross-sectional view of a cooking stone received in and engaged with a receiving aperture defined by a tray, according to the present disclosure;

FIG. 7B is a side cross-sectional view of a cooking stone received in and disengaged from a receiving aperture defined by a tray, according to the present disclosure;

FIG. 8 is a top perspective view of a cooking stone for a cooking apparatus, according to the present disclosure;

FIG. 9A is a side cross-sectional view of a cooking stone including a high-thermal mass layer and a first implementation of an adapter layer coupled to the high-thermal mass layer, according to the present disclosure;

FIG. 9B is a side cross-sectional view of a cooking stone including a high-thermal mass layer and a second implementation of an adapter layer coupled to the high-thermal mass layer, according to the present disclosure;

FIG. 9C is a side cross-sectional view of a cooking stone including a high-thermal mass layer and a third implementation of an adapter layer coupled to the high-thermal mass layer, according to the present disclosure;

FIG. 9D is a side cross-sectional view of a cooking stone including a high-thermal mass layer and a fourth implementation of an adapter layer coupled to the high-thermal mass layer, according to the present disclosure;

FIG. 10 is a perspective view of a lid for a cooking apparatus, according to the present disclosure;

FIG. 11 is a top perspective view of a cooking apparatus including a tray and a lid disposed over a cooking surface, according to the present disclosure;

FIG. 12 is a side cross-sectional view of a cooking apparatus including a cooking stone, a tray, and a lid including a heating element, according to the present disclosure;

FIG. 13 is a flow diagram for a method for cooking a food item with a cooking apparatus, according to the present disclosure;

FIG. 14 is a flow diagram for a method for cooking a food item with a cooking apparatus, according to the present disclosure; and

FIG. 15 is a flow diagram for a method for cooking a food item with a cooking apparatus, according to the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a pizza stone. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

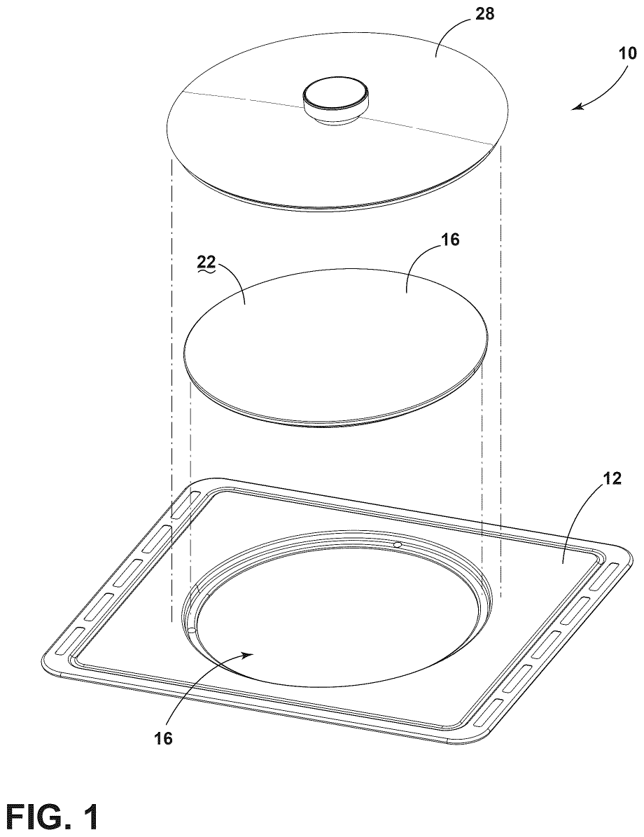

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

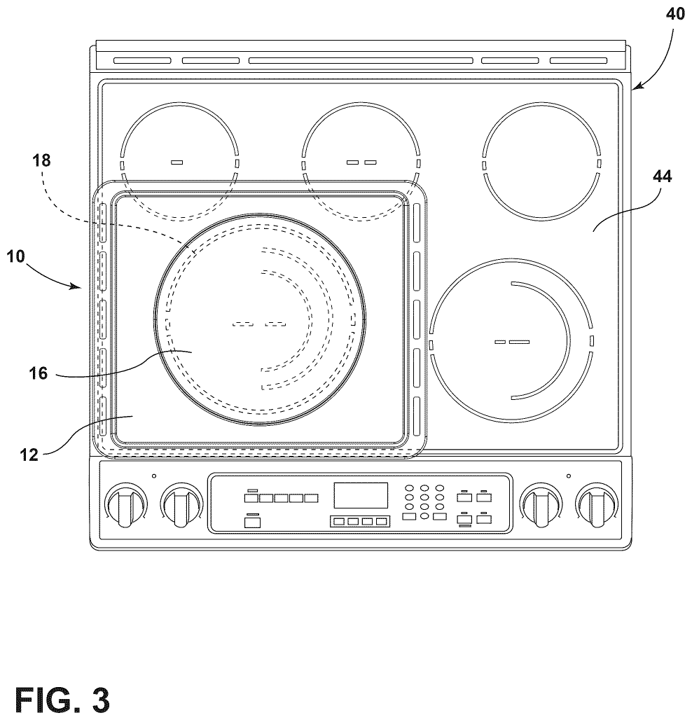

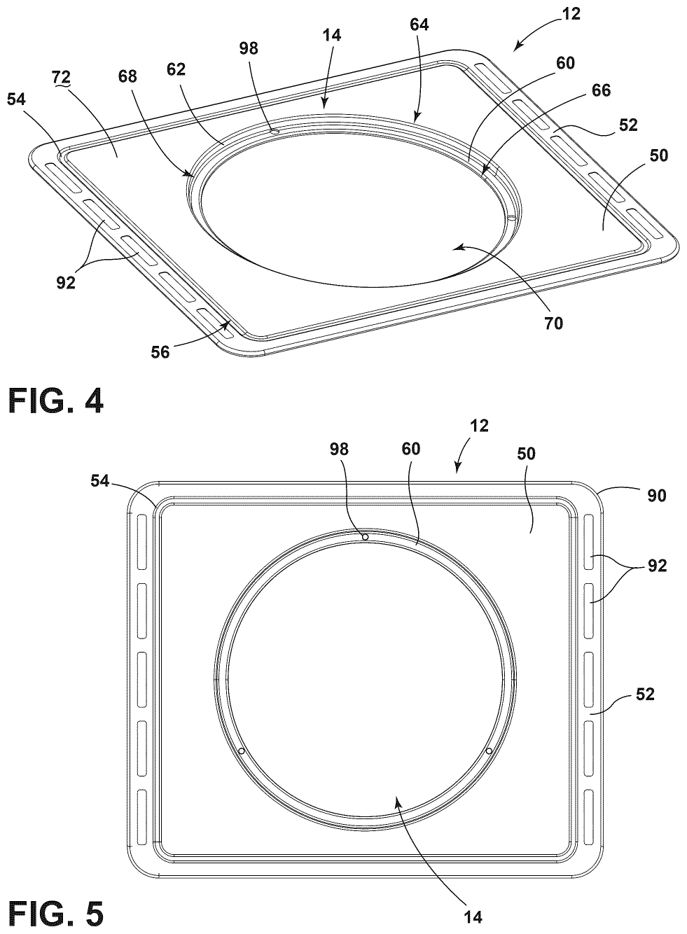

Referring to FIGS. 1-15, reference numeral 10 generally designates a cooking apparatus or a pizza stone. The cooking apparatus 10 includes a tray 12 defining a receiving aperture 14. A cooking stone 16 is selectively disposed within the receiving aperture 14 of the tray 12. The cooking stone 16 separates from the tray 12 when disposed over a heat source 18. The cooking stone 16 incudes a high-thermal mass layer 20 defining a cooking surface 22 and an adapter layer 24 coupled to a lower surface 26 of the high-thermal mass layer 20. A lid 28 is selectively disposed over the cooking surface 22.

Referring to FIGS. 1-3, the cooking apparatus 10 includes the tray 12, the cooking stone 16 defining the cooking surface 22, and the lid 28. The cooking apparatus 10 is generally configured to cook or heat a food item, such as a pizza, disposed on the cooking surface 22 of the cooking stone 16 when used in conjunction with a cooking appliance 40. The cooking appliance 40 may include a cooking cavity 42 and a cooktop 44 including the heat source 18. The cooking apparatus 10 may be disposed within the cooking cavity 42 or disposed over the heat source 18 to cook the food item. The cooking appliance 40 used with the cooking apparatus 10 may be a traditional oven range including the cooking cavity 42 and the cooktop 44. Additionally, the cooking cavity 42 may be heated via a gas heating element and/or an electric heating element. The cooktop 44 may include a plurality of heating sources, which includes the heat source 18. The plurality of heating sources may be gas burners, radiant electric heating elements, or induction burners.

While the cooking apparatus 10 is discussed as being used with the cooking appliance 40, the cooking apparatus 10 may be used with multiple cooking appliances. The multiple cooking appliances may include a first cooking appliance including the cooking cavity 42 and a second cooking appliance including the cooktop 44 defining the heat source 18. The separate cooking appliance may be used in a similar manner as discussed with reference to the cooking appliance 40. Alternatively, in some implementations, the cooking apparatus 10 may be used with an appliance including either the cooking cavity 42 or the cooktop 44 defining the heat source 18.

Referring to FIGS. 1, 4 and 5, the cooking apparatus 10 includes the tray 12 defining the receiving aperture 14 configured to selectively retain the cooking stone 16. The tray 12 may include a central portion 50 that defines the receiving aperture 14 and an outer portion 52 extending around the central portion 50. The outer portion 52 may be coupled to the central portion 50. In some implementations, the central portion 50 may be recessed relative to the outer portion 52. In other implementations, the central portion 50 may define a channel 54 extending around a perimeter 56 of the central portion 50.

The receiving aperture 14 may include a support ledge 60 and a side wall 62. The side wall 62 extends between the central portion 50 and the support ledge 60. The side wall 62 may extend from an outer perimeter 64 of the receiving aperture 14 In some implementations, the side wall 62 may extend perpendicular to the central portion 50. In other implementations, the side wall 62 may extend at an angle from the central portion 50. The support ledge 60 is generally configured to support the cooking stone 16. The support ledge 60 may extend from the side wall 62 toward a center of the receiving aperture 14. In some implementations, the support ledge 60 may extend perpendicular to the side wall 62. In other implementations, the support ledge 60 may extend at an angle from the side wall 62. The support ledge 60 may define an inner perimeter 66 of the receiving aperture 14.

The receiving aperture 14 may include an upper aperture 68 defined by the outer perimeter 64 and a lower aperture 70 defined by the inner perimeter 66. As illustrated, the shape of the outer perimeter 64 and the upper aperture 68 is circular. However, the shape of the outer perimeter 64 and the upper aperture 68 may be any shape, including ovals, squares, rectangles, or other shapes. As illustrated, the shape of the inner perimeter 66 and the lower aperture 70 is circular. However, the shape of the inner perimeter 66 and the lower aperture 70 may be any shape, including ovals, squares, rectangles, or other shapes.

In some implementations, the shape of the outer perimeter 64 and the shape of the inner perimeter 66 may be the same or substantially the same shape. In other implementations, the shape of the outer perimeter 64 and the shape of the inner perimeter 66 may be different. When the shape of the outer perimeter 64 and the shape of the inner perimeter 66 are different, the support ledge 60 may have inconsistent depth between the side wall 62 and the inner perimeter 66. The varied shape of the outer perimeter 64 and the inner perimeter 66 may align the cooking stone 16 when engaged with the receiving aperture 14, as discussed further herein. The tray 12 may be constructed of a metal, a metal alloy, or other material that may support the cooking stone 16. The material the tray 12 is constructed of may be heat resistant or may withstand heat of the cooking cavity 42 and/or the cooktop 44.

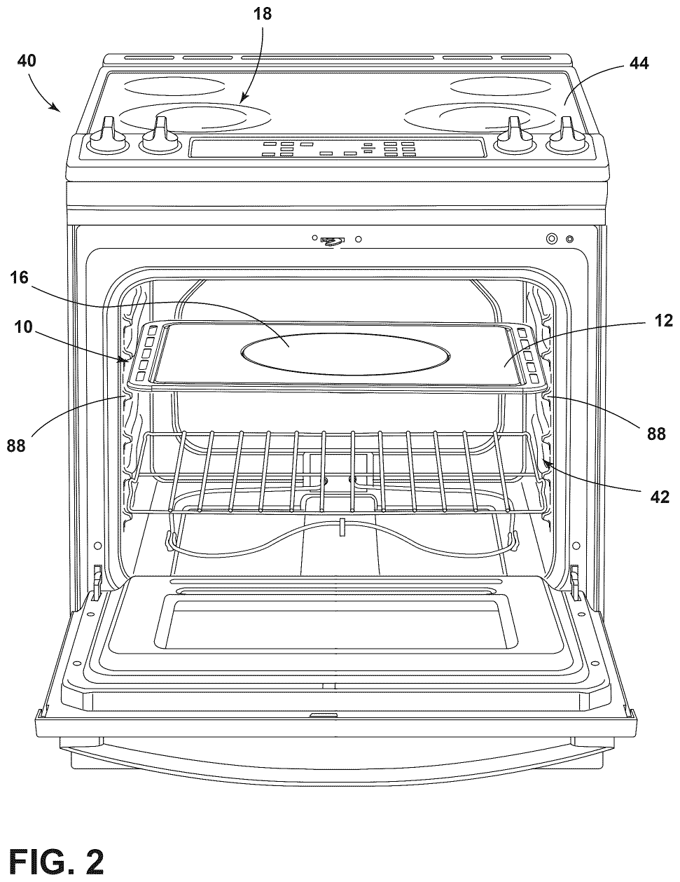

Referring still to FIGS. 1, 4 and 5, and again FIG. 2, the tray 12 may be configured to be supported by supports 88 within the cooking cavity 42 of the cooking appliance 40. Stated differently, the tray 12 may be configured as an oven rack. In some implementations, the tray 12 may slidably engage the supports 88, allowing for the cooking appliance 40 to be slide into the cooking cavity 42. The outer portion 52 of the tray 12 may engage the supports 88 when disposed in the cooking cavity 42. To engage the supports 88, the outer portion 52 may include a rolled edge 90 or a rounded edge 90. The outer portion 52 of the tray 12 may include vent apertures 92. The vent apertures 92 allow for air to flow within the cooking cavity 42 when the tray 12 is disposed therein.

The tray 12 may also include feet 94 to support and space the tray 12 away from a surface 96, such as the cooktop 44. The support ledge 60 may define apertures 98 configured to receive the feet 94. The apertures 98 may be spaced along the support ledge 60 and around the lower aperture 70. In some implementations, the feet 94 may be coupled to the tray 12 with fasteners extending through the apertures 98. In other implementations, the feet 94 may extend through the apertures 98 and engage the support edge. For example, the feet 94 may be rubber feet 94 that may be partially pushed through the apertures 98 and be coupled to the tray 12.

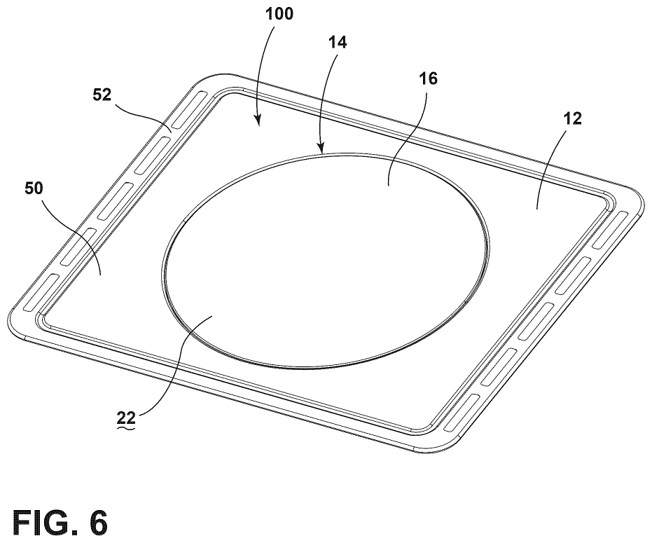

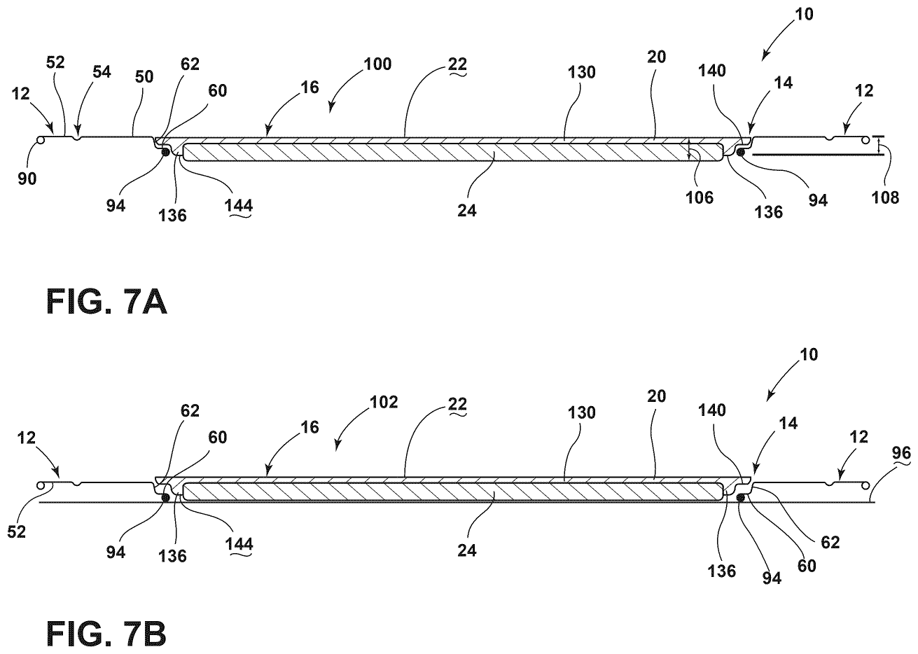

Referring to FIGS. 6-8, the cooking stone 16 is may selectively disposed within the receiving aperture 14 of the tray 12. The cooking stone 16 may be in an engaged position 100, a disengaged position 102, and a separated or freestanding position. As illustrated in FIGS. 6 and 7A, the cooking stone 16 in the engaged position 100 is received within the receiving aperture 14 and is supported by the support ledge 60. The cooking surface 22 may be flush or substantially flush with an upper surface 72 of the central portion 50 of the tray 12. The cooking stone 16 may extend through the upper aperture 68 and the lower aperture 70 when in the engaged position.

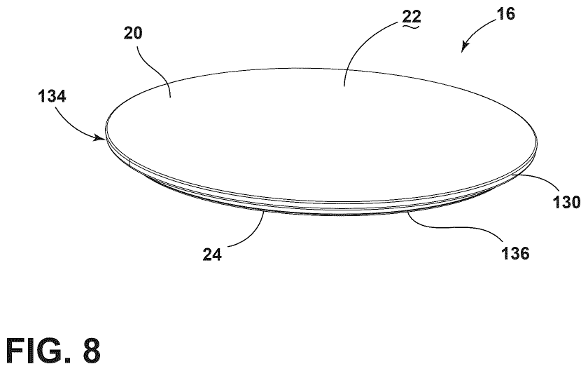

As illustrated in FIG. 7B, the cooking stone 16 in the disengaged position 102 is spaced from the support ledge 60 and extends through the receiving aperture 14 of the tray 12. In the disengaged position 102, the cooking stone 16 and the tray 12 may be supported by the surface 96. The cooking stone 16 may have a height 106 that is greater than a height 108 of the tray 12. In some implementations, the height 108 of the tray 12 is the distance between the central portion 50 of the tray 12 and the support ledge 60 of the receiving aperture 14. In other implementations, the height 108 of the tray 12 is the distance between the central portion 50 and the feet 94. In the disengaged position 102, the cooking stone 16 may extend through the upper aperture 68 and the lower aperture 70. As illustrated in FIG. 8, the cooking stone in the freestanding position is spaced from and is not received by extends through the receiving aperture 14 of the tray 12.

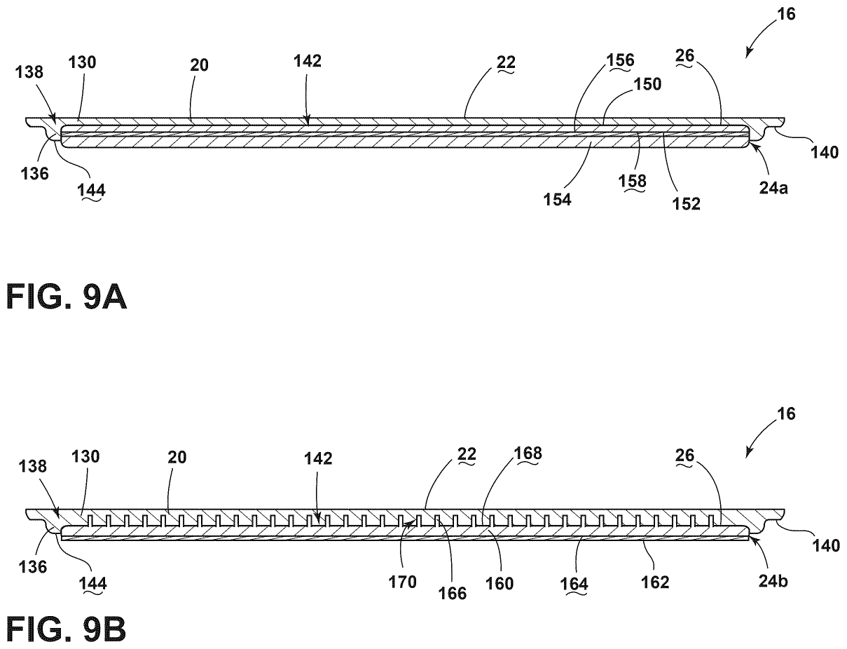

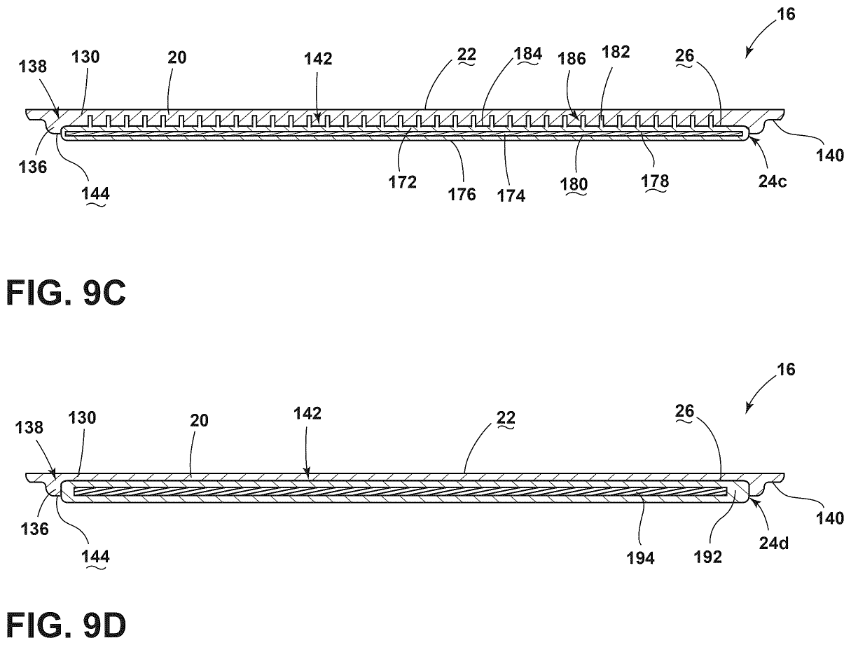

Referring to FIGS. 8-9C, the cooking stone 16 includes the high-thermal mass layer 20 and the adapter layer 24 coupled to the lower surface 26 of the high-thermal mass layer 20. The high-thermal mass layer 20 generally includes an upper portion 130 or a body portion 130 defining the cooking surface 22 and the lower surface 26. The lower surface 26 of the upper portion 130 may be directly opposing the cooking surface 22. As illustrated, an outer perimeter 134 of the high-thermal mass layer 20 is a circle. However, it is contemplated that the outer perimeter 134 of the upper portion 130 may be an oval, square, rectangle, or any other shape. Additionally, it is contemplated that the outer perimeter 134 of the upper portion 130 has the same or substantially the same shape as the outer perimeter 64 of the receiving aperture 14.

An outer wall 136 may extend from the lower surface 26 of the high-thermal mass layer 20. The outer wall 136 may have a perimeter 138 having the same of the outer perimeter 134 of the upper portion 130. As illustrated, both the outer perimeter 134 of the upper portion 130 and the perimeter 138 of the outer wall 136 are circular. However, the shape of the perimeter 138 of the outer wall 136 may be different than the shape of the outer perimeter 134. For example, the shape of the outer perimeter 134 of the upper portion 130 may be oval and the shape of the perimeter 138 of the outer wall 136 may be a circle. Additionally, it is contemplated that the shape of the perimeter 138 of the outer wall 136 may be the same or substantially the same as the inner perimeter 66 of the receiving aperture 14.

The outer wall 136 generally extends from the lower surface 26 spaced from the outer perimeter 134 of the upper portion 130. The lower surface 26 between the outer wall 136 and the outer perimeter 134 of the upper portion 130 defines an outer edge 140 or an outer lip 140. The outer edge 140 may be configured to engage the support ledge 60 when the cooking stone 16 is in the engaged position 100. In some implementations where the outer perimeter 134 of the upper portion 130 and the perimeter 138 of the outer wall 136 are the same shape, the outer edge 140 may have a consistent spacing between the outer perimeter 134 and the perimeter 138 of the outer perimeter 134. In other implementations, the outer edge 140 may have varied spacing between the outer perimeter 134 of the upper portion 130 and the perimeter 138 of the outer wall 136.

The outer wall 136 may define a recess 142 configured to at least partially receive the adapter layer 24. In some implementations, the recess 142 may have a similar shape as the perimeter 138 of the outer wall 136. In other implementations, the recess 142 may have a different shape than the perimeter 138 of the outer wall 136.

The high-thermal mass layer 20 is generally configured to absorb and retain. The high-thermal mass layer 20 assists in cooking the food item disposed on the cooking surface 22 by maintaining a consistent or substantially consistent temperature during a cooking process. The high-thermal mass layer 20 may maintain or substantially maintain the temperature even when the food item is introduced at a lower temperature. The high-thermal mass layer 20 may be constructed of various materials having a high-thermal mass. For example, the high-thermal mass layer 20 may be constructed of stone, brick, steel, stainless steel, cast iron, ceramics, or other high-thermal mass materials.

Referring to FIGS. 9A-9D, the adapter layer 24 may be coupled to the lower surface 26 of the high-thermal mass layer 20. The adapter layer 24 may be coupled to the high-thermal mass layer 20 within the recess 142. In some implementations, the adapter layer 24 may have the same shape as the recess 142 and may extend between the outer wall 136. In other implementations, the adapter layer 24 may have a different shape than the recess 142 and may not extend between the outer wall 136. The adapter layer 24 may be received or partially received within the recess 142 of the high-thermal mass layer 20. Stated differently, the adapter layer 24 may extend beyond an end surface 144 of the outer wall 136.

The adapter layer 24 is generally configured to transfer heat to the high-thermal mass layer 20. The adapter layer 24 may transfer heat from the cooktop 44 and/or the cooking cavity 42 to the high-thermal mass layer 20. Additionally, the adapter layer 24 may be configured to interact with an induction burner, which allows for the cooking stone 16 to be heated by the induction burner. The adapter layer 24 may be constructed of a variety of materials allowing for the heat transfer to the high-thermal mass layer 20. In some implementations, the adapter layer 24 is a single layer including a single material. In other implementations, the adapter layer 24 is multiple layers of at least two or more materials. Implementations of the adapter layer 24 including multiple layers may be constructed of the same number of materials as layers or may include more layers than materials used (i.e., two or more layers are constructed of the same materials).

Referring to FIG. 9A, a first exemplary implementation of an adapter layer 24a is illustrated. The adapter layer 24a includes an aluminum layer 150, a cast iron layer 152, and a stainless-steel layer 154. The aluminum layer 150 may be coupled to the lower surface 26 of the high-thermal mass layer 20. The cast iron layer 152 may be coupled to a lower surface 156 of the aluminum layer 150. The stainless-steel layer 154 may be coupled to a lower surface 158 of the cast iron layer 152. Each of the layers 150, 152, 154, of the adapter layer 24a may be received or partially received within the recess 142 or the high-thermal mass layer 20.

Referring to FIG. 9B, a second exemplary implementation of an adapter layer 24b is illustrated. The adapter layer 24b is an aluminum layer 160 coupled to the lower surface 26 of the high-thermal mass layer 20 and a stainless-steel layer 162 coupled to a lower surface 164 of the aluminum layer 160. The aluminum layer 160 includes a plurality of raised portions 166 distributed over an upper surface 168 of the aluminum layer 160. The raised portions 166 of the aluminum layer 160 are received in a corresponding plurality of recessed portions 170 of the high-thermal mass layer 20. The raised portions 166 of the aluminum layer 168 and the recessed portions 170 of the high-thermal mass layer 20 increase the area of contact between the adapter layer 24b and the high-thermal mass layer 20, allowing for increase heat transfer therebetween. Each of the layers 160, 162, 164, of the adapter layer 24b may be received or partially received within the recess 142 or the high-thermal mass layer 20.

Referring to FIG. 9C, a third exemplary implementation of an adapter layer 24c is illustrated. The adapter layer 24c includes an aluminum layer 172, a cast iron layer 174, and a stainless-steel layer 176. The aluminum layer 172 is coupled to the lower surface 26 of the high-thermal mass layer 20, the cast iron layer 174 is coupled to a lower surface 178 of the aluminum layer 172, and the stainless-steel layer 162 is coupled to a lower surface 180 of the cast iron layer 174. The aluminum layer 172 includes a plurality of raised portions 182 distributed over an upper surface 184 of the aluminum layer 172. The raised portions 182 of the aluminum layer 172 are received in a corresponding plurality of recessed portions 186 of the high-thermal mass layer 20. The raised portions 182 of the aluminum layer 172 and the recessed portions 186 of the high-thermal mass layer 20 increase the area of contact between the adapter layer 24c and the high-thermal mass layer 20, allowing for increase heat transfer therebetween. Each of the layers 172, 174, 176, of the adapter layer 24c may be received or partially received within the recess 142 or the high-thermal mass layer 20.

Referring to FIG. 9D, a fourth exemplary implementation of an adapter layer 24d is illustrated. The adapter layer 24c includes an aluminum layer 192 and a stainless-steel layer 194. The aluminum layer 192 is coupled to the lower surface 26 of the high-thermal mass layer 20. The stainless-steel layer 194 is disposed within the aluminum layer 192. Stated differently, the aluminum layer 192 encompasses or extends around the stainless-steel layer 194. By encompassing the stainless-steel layer 194 with the aluminum layer 192, the stainless-steel layer 194 and the aluminum layer 192 have a large surface area for heat transfer. The large surface area allows for the stainless-steel layer 194 when interacting with an induction burner to transfer heat to the aluminum layer 192 efficiently. The aluminum layer 192 of the adapter layer 24d may be received or partially received within the recess 142 or the high-thermal mass layer 20.

Referring to FIGS. 9A-9D, the adapter layer 24 is not limited to the materials discussed. The adapter layer 24 may be constructed of one or more materials having a high thermal conductivity, which allows for efficient heat transfer from the cooktop 44 and/or the cooking cavity 42 to the high-thermal mass layer 20. For example, materials for the adapter layer 24 having a high thermal conductivity may include aluminum, copper, or other metals and metal alloys. Additionally, or alternatively, the adapter layer 24 may be constructed of one or more materials that interact with the induction burner. For example, materials for the adapter layer 24 that interact with an induction burner may include steel, stainless-steel, cast iron, or other metals and metal alloys.

Additionally, the adapter layer 24 is not limited to the configuration of layers discussed. The adapter layer 24 may include one layer of material, two layers of material, or three or more layers of material. For example, the adapter layer 24 may include an aluminum layer similar to the second exemplary adapter layer 24b and a cast iron layer similar to the first exemplary adapter layer 24a. Further, when the adapter layer 24 includes multiple layers, the layers may not have a distinct break or delineation, as illustrated in FIGS. 9A-9D, but may include a transition gradient between the layers. Further, the layers of the adapter layer 24 are not limited to the materials discussed specifically and may be a variety of materials configured for each of the layers discussed.

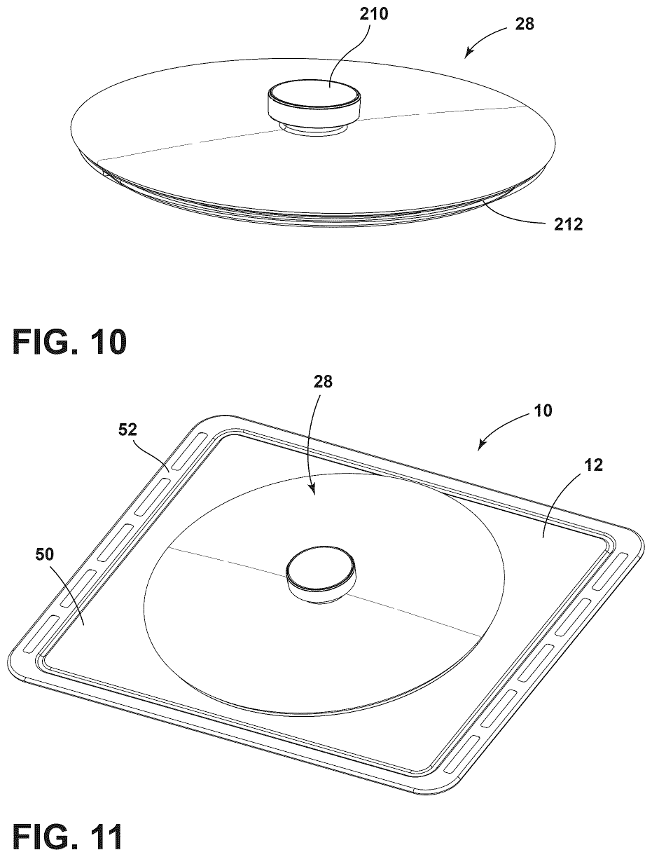

Referring to FIGS. 10 and 11, the cooking apparatus 10 may also include the lid 28 to selectively dispose over the cooking surface 22 of the cooking stone 16. The lid 28 may include a handle 210 and a gasket 212 extending around the lid 28. The handle 210 is coupled to the lid 28 and may be configured to move the lid 28 between a first position disposed over the cooking surface 22 (as illustrated in FIG. 11) and a second position that does not cover the cooking surface 22. The lid 28 may be constructed of glass, metal, metal alloys, polymers or other materials allowing for the heating of the cooking surface 22.

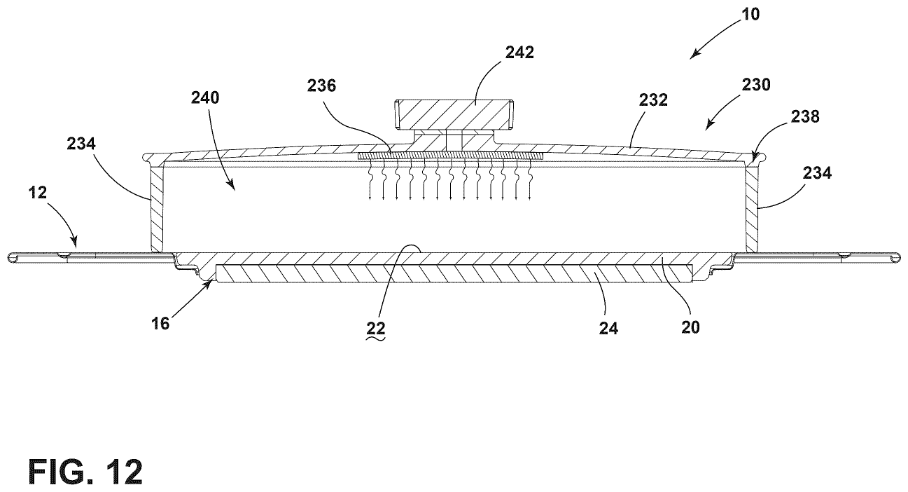

Referring to FIG. 12, in a second implementation of a lid 230 for the cooking apparatus 10, the lid 230 may include a top wall 232, a side wall 234, and a heating element 236. The side wall 234 may be coupled to the top wall 232. The side wall 234 may extend around a perimeter 238 of the top wall 232. The lid 230 may be disposed over the cooking surface 22. The side wall 234 may space the top wall 232 from the cooking surface 22 when the lid 230 is disposed over the cooking surface 22. A cooking cavity 240 may be defined between the cooking surface 22 and the top wall 232 when the lid 230 is disposed over the cooking surface 22. The heating element 236 may be coupled to the top wall 232.

The heating element 236 is generally configured to heat the cooking cavity 240. The heating element 236 may be an electric heating element, a gas heating element, or an induction heating element. When the heating element 236 is an induction heating element, the heating element 236 is configured to interact with an induction cooktop to heat the cooking cavity 240. The lid 230 may also include a handle 242 coupled to the top wall 232. The handle 242 may be configured to move the lid 230 between a first position disposed over the cooking surface 22 (as illustrated in FIG. 12) and a second position that does not cover the cooking surface 22.

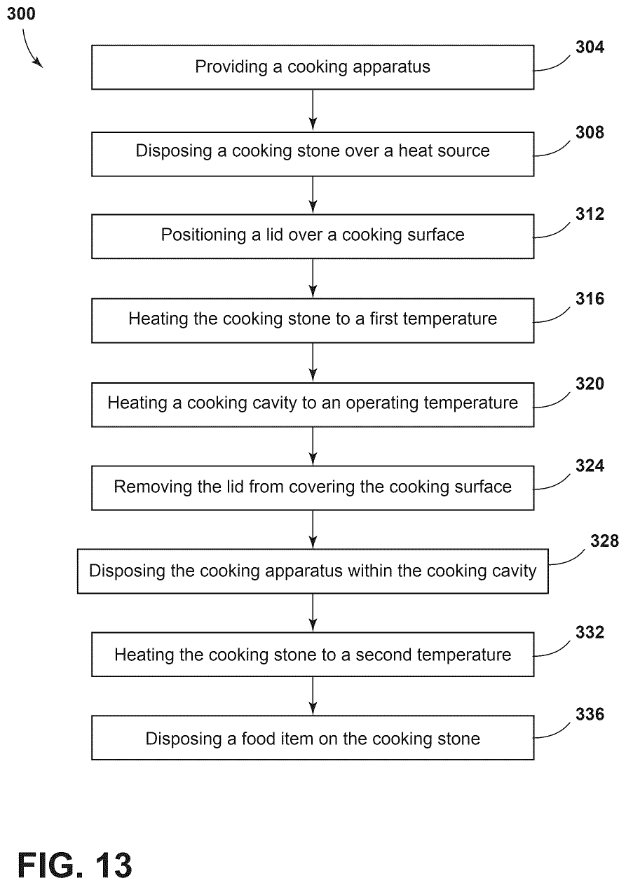

Referring to FIG. 13, with reference to FIGS. 1-11, a flow diagram for a method 300 for heating or cooking a food item with the cooking apparatus 10. The method 300 includes step 304 of providing the cooking apparatus 10. The cooking apparatus 10 may include the tray 12, the cooking stone 16, and the lid 28. The cooking stone 16 may be disposed within the receiving aperture 14 of the tray 12 (i.e., the cooking stone 16 is in the engaged position 100).

In step 308, the cooking stone 16 may be disposed over the heat source 18. The cooking stone 16 may extend through the receiving aperture 14 of the tray 12 (i.e., the cooking stone 16 is in the disengaged position 102). The heat source 18 may be the cooktop 44 of the appliance 40. The cooking stone 16 may be positioned over the heat source 18 by using the tray 12 to adjust and move the cooking stone 16. In step 312, the lid 28 may be positioned over the cooking surface 22. The lid 28 may assist with the heating of the cooking stone 16 by reducing or preventing heat from radiating away from the stone into an environment.

In step 316, the cooking stone 16 may be heated to a first temperature using the heat source 18 of the cooktop 44. The heat source 18 may be an induction burner, a gas burner, or a radiant electric burner. The induction burner may interact with the adapter layer 24 the cooking stone 16 to heat the cooking stone 16. The gas burner and the radiant burner may heat the adapter layer 24 of the cooking stone 16. When the tray 12 is disengaged from the cooking stone 16, the tray 12 may have a lower or a substantially lower temperature than the first temperature of the cooking stone 16.

In step 320, the cooking cavity 42 of the appliance 40 may be heated to an operating temperature. The cooking cavity 42 may be heated using an electric heating element or a gas heating element disposed in the cooking cavity 42. The cooking cavity 42 may begin heating the cooking cavity 42 to the operating temperature at the same time or substantially the same time as the heating of the cooking stone 16 to the first temperature is initiated. In some implementations, the heating of the cooking cavity 42 to the operation temperature in step 320 and the heating of the cooking stone 16 to the first temperature in step 316 may be controlled by a user. In other implementations, the heating of the cooking cavity 42 to the operation temperature in step 320 and the heating of the cooking stone 16 to the first temperature in step 316 may be controlled by a controller of the cooking appliance 40. The controller may be configured to determine times to initiate heating of the cooking stone 16 in step 316 and heating of the cooking cavity 42 in step 320 such that the cooking stone 16 reaches the first temperature and the cooking cavity 42 reaches the operating temperature at the same time or substantially the same time. In step 324, the lid 28 may be removed from covering or over the cooking surface 22.

In step 328, disposing the cooking apparatus 10 within the cooking cavity 42. The cooking stone 16 may be received in the receiving aperture 14 of the tray 12 when disposed in the cooking cavity 42 (i.e., the cooking stone 16 is in the engaged position 100). The tray 12 may be slidably engaged with the supports 88 of the cooking cavity 42 when disposing the receiving aperture 14 in the cooking cavity 42. Step 328 may be performed before or after the cooking cavity reaches the operating temperature.

In step 332, the cooking stone 16 may be heated to a second temperature within the cooking cavity 42. The cooking stone 16 may be heated from the first temperature to a second temperature within the cooking cavity. The first temperature may be lower than the second temperature. The second temperature may be equal or substantially equal to the operating temperature of the cooking cavity 42. However, in some instances, the first temperature of the cooking stone 16 may be greater than or equal to the operating temperature of the cooking cavity 42 from the heating in step 316. In such instances, the cooking stone 16 does not require additional heating since the cooking stone 16 has reached the highest temperature the cooking cavity 42 may heat the cooking stone 16 to. In step 336, the food item may be disposed on the cooking surface 22 of the cooking stone 16. The food item may be disposed on the cooking stone 16 before or after the cooking stone 16 is disposed in the oven.

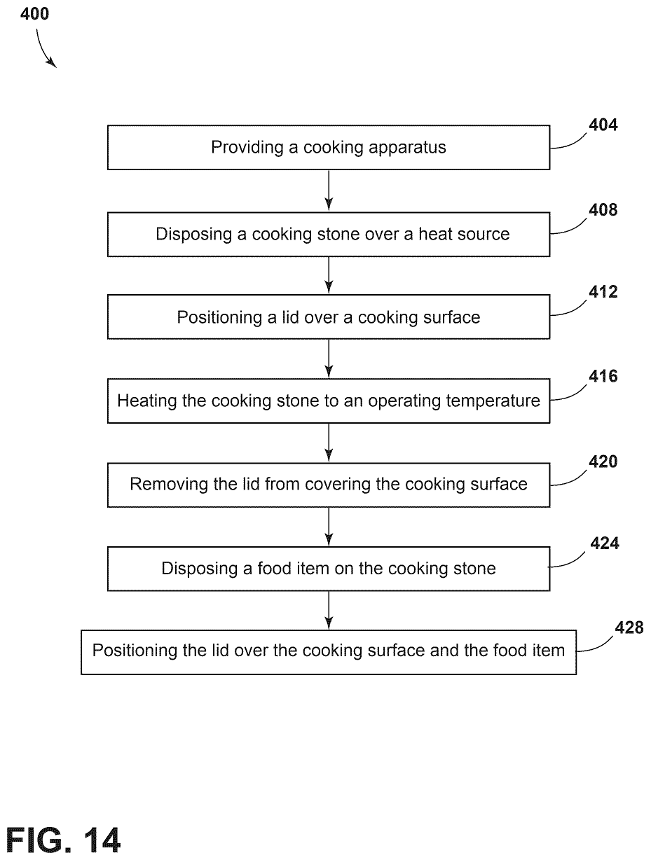

Referring to FIG. 14, with reference to FIGS. 1-11, a flow diagram for a method 400 for heating or cooking a food item with the cooking apparatus 10. The method 400 includes step 404 of providing the cooking apparatus 10. The cooking apparatus 10 may include the tray 12, the cooking stone 16, and the lid 28. The cooking stone 16 may be disposed within the receiving aperture 14 of the tray 12 (i.e., the cooking stone 16 is in the engaged position 100).

In step 408, the cooking stone 16 may be disposed over the heat source 18. The cooking stone 16 may extend through the receiving aperture 14 of the tray 12 (i.e., the cooking stone 16 is in the disengaged position 102). The heat source 18 may be the cooktop 44 of the appliance 40. The cooking stone 16 may be positioned over the heat source 18 by using the tray 12 to adjust and move the cooking stone 16. In step 412, the lid 28 may be positioned over the cooking surface 22. The lid 28 may assist with the heating of the cooking stone 16 by reducing or preventing heat from radiating away from the stone into an environment.

In step 416, the cooking stone 16 may be heated to an operating temperature using the heat source 18 of the cooktop 44. The heat source 18 may be an induction burner, a gas burner, or a radiant electric burner. The induction burner may interact with the adapter layer 24 the cooking stone 16 to heat the cooking stone 16. The gas burner and the radiant burner may heat the adapter layer 24 of the cooking stone 16. When the tray 12 is disengaged from the cooking stone 16, the tray 12 may have a lower or a substantially lower temperature than the first temperature of the cooking stone 16.

In step 420, the lid 28 may be removed from covering or over the cooking surface 22. In step 424, a food item may be disposed on the cooking stone 16. In step 428, the lid 28 may be positioned over the cooking surface 22 and the food item disposed on the cooking stone 16 during cooking of the food item.

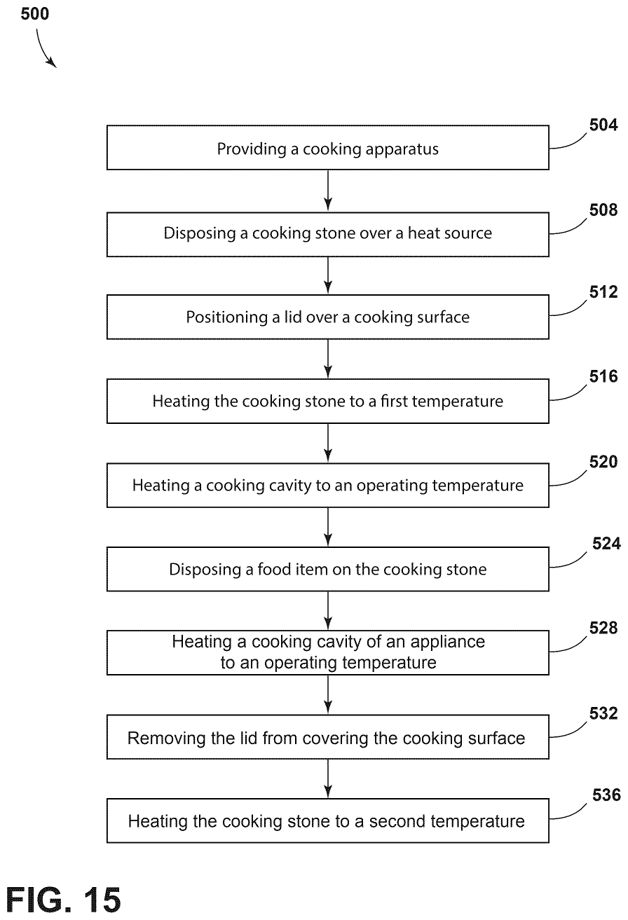

Referring to FIG. 15, with reference to FIGS. 1-10 and 12, a flow diagram for a method 400 for heating or cooking a food item with the cooking apparatus 10. The method 500 includes step 504 of providing the cooking apparatus 10. The cooking apparatus 10 may include the tray 12, the cooking stone 16, and the lid 230. The cooking stone 16 may be disposed within the receiving aperture 14 of the tray 12 (i.e., the cooking stone 16 is in the engaged position 100). In step 508, the cooking stone 16 may be disposed over the heat source 18. The cooking stone 16 may extend through the receiving aperture 14 of the tray 12 (i.e., the cooking stone 16 is in the disengaged position 102). The heat source 18 may be the cooktop 44 of the appliance 40. The cooking stone 16 may be positioned over the heat source 18 by using the tray 12 to adjust and move the cooking stone 16. In step 512, the lid 230 may be positioned over the cooking surface 22. By positioning the lid 230, the cooking cavity 240 between the lid 230 and the cooking surface 22.

In step 516, the cooking stone 16 may be heated to a first temperature using the heat source 18. The heat source 18 may be an induction burner, a gas burner, or a radiant electric burner. The cooking stone 16 may also be heated to the first temperature using the heating element 236 of the lid 230. The heating element 236 may interact with the heat source 18 configured as an induction burner. In step 520, the cooking cavity 240 may be heated to an operating temperature using the heating element 236. The first temperature and the operating temperature may be equal or substantially equal.

In step 524, the food item may be disposed on the cooking surface 22 of the cooking stone 16. The food item may be disposed on the cooking stone 16 before or after the cooking stone 16 reaches the first temperature and/or the cooking cavity 240 reaches the operating temperature. The food item may be partially or fully cooked while disposed over the heat source 18 and using the heating element 236 of the lid 230. The food item may also be partially and fully cooked while disposed in the cooking cavity 42.

In step 528, the cooking cavity 42 of the appliance 40 may be heated to an operating temperature. The cooking cavity 42 may be heated using an electric heating element or a gas heating element disposed in the cooking cavity 42. The cooking cavity 42 may begin heating the cooking cavity 42 to the operating temperature at the same time or substantially the same time as the heating of the cooking stone 16 to the first temperature is initiated. The cooking cavity 42 may be heated to the operating temperature in a similar manner as discussed with reference to the method 300. In step 532, the lid 28 may be removed from covering or over the cooking surface 22. In step 424, a food item may be disposed on the cooking stone 16. In step 536, the cooking stone 16 may be heated to a second temperature within the cooking cavity 42. The cooking stone 16 may be heated from the first temperature to a second temperature within the cooking cavity.

Use of the present device may provide a variety of advantages. The cooking stone 16 being selectively received by the tray 12 allows for the cooking stone 16 to be preheated while minimizing heating of the tray 12. The tray 12 may also be used to move the cooking stone 16 after heating of the cooking stone 16 with the heat source 18. Further, by being able to preheat the cooking stone 16 with the heat source 18, such as the cooktop 44, the time the cooking cavity 42 is active may be reduced because heat transfer from the heat source 18 to the cooking stone 16 may be more efficient than from the cooking cavity 42 to the cooking stone 16. The more efficient heating of the cooking stone 16 may also allow for more efficient cooking of food items because of a reduction in preheating time of the cooking stone 16. Additionally, the lid 28 disposed over the cooking stone 16 during heating with the heat source 18 may improve heating efficiency of the cooking stone 16.

Furthermore, the adapter layer 24 may increase the efficiency of heating the cooking stone 16 by having varied materials having different heat transfer characteristics. The adapter layer 24 may also include materials that interact with the heat source 18 configured as an induction burner, which allows for the heating of the cooking stone 16 with the induction burner. When the raised portions 166, 182 of the adapter layer 24 and the recessed portions 170, 186 of the high-thermal mass layer 20 are included, there may be more efficient heat transfer between the adapter layer 24 and the high-thermal mass layer 20. Moreover, the high-thermal mass layer 20 retaining heat allows for the cooking stone 16 to maintain a consistent or substantially consistent temperature while cooking or heating the food time. Additional benefits or advantages may be realized and/or achieved.

The device disclosed herein is further summarized in the following paragraphs and is further characterized by combinations of any and all of the various aspects described herein.

According to one aspect of the present disclosure, a cooking apparatus includes a tray defining a receiving aperture. A cooking stone is selectively disposed within the receiving aperture of the tray, where the cooking stone separates from the tray when disposed over a heat source. The cooking stone includes a high-thermal mass layer defining a cooking surface, and an adapter layer coupled to a lower surface of the high-thermal mass layer. A lid is selectively disposed over the cooking surface.

According to another aspect, an adapter layer includes an aluminum layer coupled to a high-thermal mass layer, a cast iron layer coupled to the aluminum layer, and a stainless-steel layer coupled to the cast iron layer.

According to yet another aspect, an aluminum layer includes a plurality of raised portions configured to be received by a plurality of recessed portions defined by a high-thermal mass layer.

According to another aspect, an adapter layer includes an aluminum layer, including a plurality of raised portions configured to be received by a plurality of recessed portions defined by a high-thermal mass layer. The aluminum layer is coupled to the high-thermal mass layer, and a stainless-steel layer coupled to the aluminum layer.

According to yet another aspect, a tray is configured as an oven rack.

According to another aspect, a high-thermal mass layer defines a recess configured to receive an adapter layer.

According to yet another aspect, a high-thermal mass layer includes an upper portion and an outer wall extending from a lower surface and defining a recess.

According to another aspect, a cooking stone is received within a receiving aperture when a cooking apparatus is disposed in a cooking cavity.

According to another aspect of the present disclosure, a pizza stone includes a tray defining a receiving aperture and a cooking stone selectively disposed within the receiving aperture. The cooking stone includes a high-thermal mass layer defining a cooking surface and an adapter layer coupled to a lower surface of the high-thermal mass layer.

According to another aspect, an adapter layer includes an aluminum layer coupled to a high-thermal mass layer, a cast iron layer coupled to the aluminum layer, and a stainless-steel layer coupled to the cast iron layer.

According to yet another aspect, an aluminum layer includes a plurality of raised portions configured to be received by a plurality of recessed portions defined by a high-thermal mass layer.

According to another aspect, an adapter layer includes an aluminum layer including a plurality of raised portions configured to be received by a plurality of recessed portions defined by a high-thermal mass layer. The aluminum layer is coupled to the high-thermal mass layer, and a stainless-steel layer is coupled to the aluminum layer.

According to yet another aspect, a lid is selectively disposed over a cooking surface.

According to another aspect, a lid includes a top wall, a side wall coupled to and extending around a perimeter of the top wall. The side wall is configured to space the top wall away from a cooking stone when disposed over a cooking surface. A cooking cavity is defined between the cooking surface and the top wall when the lid is disposed over the cooking surface. A heating element is coupled to the top wall, where the heating element is configured to interact with an induction cooktop and heat the cooking cavity.

According to yet another aspect of the present disclosure, a method for heating a cooking apparatus includes providing the cooking apparatus, where the cooking apparatus includes a tray defining a receiving aperture and a cooking stone selectively engages the receiving aperture, disposing the cooking stone over a heat source, where the cooking stone extends through the receiving aperture of the tray and is disengaged from the tray, and heating the cooking stone to a first temperature by activating the heat source. The method further includes heating a cooking cavity of a cooking appliance to an operation temperature, disposing the cooking apparatus within the cooking cavity, and disposing the food item on a cooking surface defined by the cooking stone.

According to another aspect, a step of heating a cooking cavity to an operation temperature and a step of heating a cooking stone to a first temperature are initiated concurrently.

According to yet another aspect, a method for heating a cooking apparatus includes positioning a lid over a cooking surface defined by a cooking stone before a step of heating the cooking stone and removing the lid from over the cooking surface after the cooking stone reaches a first temperature.

According to another aspect, a method for heating a cooking apparatus includes heating a cooking stone from a first temperature to a second temperature within a cooking cavity.

According to yet another aspect, an operating temperature and a second temperature are the same temperature.

According to another aspect, an operating temperature and a first temperature are the same temperature.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooking apparatus, comprising:
a tray defining a receiving aperture;
a cooking stone selectively disposed within the receiving aperture of the tray, wherein the cooking stone is spaced from the tray when disposed over a heat source, and wherein the cooking stone includes:
a high-thermal mass layer defining a cooking surface; and
an adapter layer coupled to a lower surface of the high-thermal mass layer; and
a lid selectively disposed over the cooking surface.

2. The cooking apparatus of claim 1, wherein the adapter layer includes:
an aluminum layer coupled to the high-thermal mass layer;
a cast iron layer coupled to the aluminum layer; and
a stainless-steel layer coupled to the cast iron layer.

3. The cooking apparatus of claim 2, wherein the aluminum layer includes a plurality of raised portions configured to be received by a plurality of recessed portions defined by the high-thermal mass layer.

4. The cooking apparatus of claim 1, wherein the adapter layer includes:
an aluminum layer including a plurality of raised portions configured to be received by a plurality of recessed portions defined by the high-thermal mass layer, wherein the aluminum layer is coupled to the high-thermal mass layer; and
a stainless-steel layer coupled to the aluminum layer.

5. The cooking apparatus of claim 1, wherein the tray is configured as an oven rack.

6. The cooking apparatus of claim 1, wherein the high-thermal mass layer defines a recess configured to receive the adapter layer.

7. The cooking apparatus of claim 6, wherein the high-thermal mass layer includes an upper portion and an outer wall extending from the lower surface and defining the recess.

8. The cooking apparatus of claim 1, wherein the cooking stone is received within the receiving aperture when the cooking apparatus is disposed in a cooking cavity.

9. A pizza stone, comprising:
a tray defining a receiving aperture; and
a cooking stone selectively disposed within the receiving aperture, wherein the cooking stone includes:
a high-thermal mass layer defining a cooking surface; and
an adapter layer coupled to a lower surface of the high-thermal mass layer.

10. The pizza stone of claim 9, wherein the adapter layer includes:
an aluminum layer coupled to the high-thermal mass layer;
a cast iron layer coupled to the aluminum layer; and
a stainless-steel layer coupled to the cast iron layer.

11. The pizza stone of claim 10, wherein the aluminum layer includes a plurality of raised portions configured to be received by a plurality of recessed portions defined by the high-thermal mass layer.

12. The pizza stone of claim 9, wherein the adapter layer includes:
an aluminum layer including a plurality of raised portions configured to be received by a plurality of recessed portions defined by the high-thermal mass layer, wherein the aluminum layer is coupled to the high-thermal mass layer; and
a stainless-steel layer coupled to the aluminum layer.

13. The pizza stone of claim 9, further comprising:
a lid selectively disposed over the cooking surface.

14. The pizza stone of claim 13, wherein the lid includes:
a top wall;
a side wall coupled to and extending around a perimeter of the top wall, wherein the side wall is configured to space the top wall away from the cooking stone when disposed over the cooking surface, and wherein a cooking cavity is defined between the cooking surface and the top wall when the lid is disposed over the cooking surface; and
a heating element coupled to the top wall, wherein the heating element is configured to interact with an induction cooktop and heat the cooking cavity.

15. A method for cooking a food item with a cooking apparatus, comprising:
providing the cooking apparatus, wherein the cooking apparatus includes a tray defining a receiving aperture and a cooking stone selectively engages the receiving aperture;
disposing the cooking stone over a heat source, wherein the cooking stone extends through the receiving aperture of the tray and is disengaged from the tray;
heating the cooking stone to a first temperature by activating the heat source;
heating a cooking cavity of a cooking appliance to an operation temperature;
disposing the cooking apparatus within the cooking cavity; and
disposing the food item on a cooking surface defined by the cooking stone.

16. The method of claim 15, wherein the step of heating the cooking cavity to the operation temperature and the step of heating the cooking stone to the first temperature are initiated concurrently.

17. The method of claim 15, further comprising:
positioning a lid over a cooking surface defined by the cooking stone before the step of heating the cooking stone; and
removing the lid from over the cooking surface after the cooking stone reaches the first temperature.

18. The method of claim 15, further comprising:
heating the cooking stone from the first temperature to a second temperature within the cooking cavity.

19. The method of claim 18, wherein the operating temperature and the second temperature are the same temperature.

20. The method of claim 15, wherein the operating temperature and the first temperature are the same temperature.
